(19) United States
(12) Patent Application Publication
(10) Pub. No.: US 2025/0273977 A1
(43) Pub. Date: Aug. 28, 2025

(54) Ground Compaction Device with Apparatus for Increasing Rechargeable Battery Operation Time and Rechargeable Battery Service Life

(71) Applicant: Wacker Neuson Produktion GmbH & Co. KG, Reichertshofen (DE)

(72) Inventors: Christian Glanz, Dachau (DE); Martin Kaeser, Haimhausen (DE); Matthias Bachmann, Neuburg (DE)

(21) Appl. No.: 19/061,172

(22) Filed: Feb. 24, 2025

(30) Foreign Application Priority Data
Feb. 27, 2024 (DE) 10 2024 105 417.4

(51) Int. Cl. H02J 7/00; E02D 3/046

(52) U.S. Cl. CPC H02J 7/0063; E02D 3/046; H02J 2207/20

(57) ABSTRACT

A ground compaction device has a working device for generating a working movement for ground compaction, an electric drive for driving the working device, an electrical energy storage for providing electrical energy for the electric drive, and a converting apparatus for converting a direct current voltage that can be drawn from the energy storage into an alternating current voltage for the electric drive. The converting apparatus is designed to provide the alternating voltage at a predetermined control frequency when the direct current voltage drawn from the energy storage is present at a direct current voltage value above a predetermined threshold voltage value, and to provide the alternating current voltage at a reduced frequency which is lower than the control frequency when the direct current voltage obtained from the energy storage is present at a direct current voltage value equal to or below the threshold voltage value.

### BACKGROUND OF THE INVENTION

### 1. Field of the Invention

The invention relates to a ground compaction device powered by a rechargeable battery.

### 2. Description of the Related Art

Ground compaction devices, in particular tampers or vibrating plates, are known. They have a drive which, with the help of a working device, causes a working movement, in particular a tamping movement or a vibrating movement, which is transmitted to the ground to be compacted with the aid of a tamper foot or a ground contact plate.

Increasingly, ground compaction devices which are driven by an electric drive which draws its energy from an electric energy storage (rechargeable battery) are becoming known. In such apparatuses driven by a rechargeable battery, the electric drive has an electric motor, e.g. a synchronous machine, which must be supplied with an alternating current voltage at a certain frequency, e.g. 150 Hz. However, the rechargeable battery only provides a direct current voltage. A converter is provided to convert the direct current voltage supplied by the rechargeable battery into the alternating current voltage for the electric drive.

The capacity of the rechargeable battery is naturally limited. If the rechargeable battery is discharged during operation, its state of charge (SOC) is reduced. When the state of charge is low, the voltage of the rechargeable battery and thus the voltage present in the converter is also reduced due to the cell chemistry in the rechargeable battery. However, due to the fixed frequency set by the converter, constant power is required from the electric motor. In order to keep the power constant, the motor currents must be increased when the voltage of the rechargeable battery falls, due to the physical relationship of power=voltage×current. The lower voltage can also increase the slip in the motor, which leads to thermal deterioration (heating) and results in a higher cooling requirement.

The decrease in the voltage provided by the rechargeable battery (direct current voltage) during operation and the higher currents required as a result lead to a reduction in the rechargeable battery operation time and the rechargeable battery service life, a higher cooling requirement for the rechargeable battery cells and a reduced operation time of the electric drive.

### SUMMARY OF THE INVENTION

The invention is therefore based on the object of providing a ground compaction device in which said problems, in particular the reduction in rechargeable battery operation time, do not occur or only occur to a lesser extent.

The object is achieved by a ground compaction device having a working device for generating a working movement for ground compaction, an electric drive for driving the working device, an electric energy storage for providing electric energy for the electric drive, and a converter apparatus for converting a direct current voltage which can be drawn from the energy storage into an alternating current voltage for the electric drive. The converting apparatus is adapted to provide the alternating current voltage at a predetermined control frequency when the direct current voltage drawn from the energy storage is at a direct current voltage value above a predetermined threshold voltage value, and to provide the alternating current voltage at a reduced frequency which is lower than the control frequency when the direct current voltage drawn from the energy storage is at a direct current voltage value equal to or below the threshold voltage value.

The working device is used to produce the working movement that can be used for concrete compaction, e.g. a tamping movement or a vibrating movement. The electric drive is used to drive the working device and in particular has an electric motor.

The electronic drive draws its electrical energy from the electrical energy storage, in particular a rechargeable battery. The rechargeable battery can be permanently integrated into the ground compaction device. Alternatively, it can be designed to be replaceable so that it can be quickly exchanged with a freshly charged rechargeable battery when empty.

The converting apparatus (converter) converts the direct current voltage drawn from the electrical energy storage (rechargeable battery) into an alternating current voltage suitable for the electric motor. Accordingly, the alternating current voltage has a frequency that corresponds to the motor frequency and is suitable for driving the electric motor at the desired rotational speed. In practice, frequency values between 100 and 300 Hz, e.g. 150 Hz, have proven to be well suited. As the motor is to be operated at this frequency during operation, it is also referred to below as the “control frequency”. The converter can also include the rechargeable battery control (battery management system—BMS) or be part of the rechargeable battery control. It is also possible for the converter to be permanently integrated into the ground compaction device.

The battery management system BMS should always be connected to the rechargeable battery. If the rechargeable battery can be replaced, it is advisable that the battery management system BMS can also be replaced with the rechargeable battery. In this case, the converter permanently integrated into the ground compaction device remains with the ground compaction device, while the rechargeable battery with its BMS can be removed in a replaceable manner.

The voltage drawn from the rechargeable battery (direct current voltage) and, if applicable, the current drawn from the rechargeable battery can be measured continuously. Suitable measuring apparatuses can be provided for this purpose, e.g. in the converter. It is also possible for the voltage or current to be measured by the BMS. The voltage or current value measured by the BMS can then be communicated to the converter in a suitable manner.

Due to its uniformity and good detectability, the rechargeable battery voltage (direct current voltage) can be used as a signal for adjusting the frequency accordingly. As long as the direct current voltage drawn from the rechargeable battery is determined to be above the predetermined threshold voltage value, the frequency can be kept at the specified control frequency value. However, if the voltage falls below the predetermined threshold voltage, the frequency of the alternating current voltage and thus the motor frequency is also reduced, specifically to below the control frequency.

The threshold voltage value can be selected depending on the maximum direct current voltage that can be provided by the rechargeable battery. If the rechargeable battery can typically provide a direct current voltage between 40 and 60 V, the threshold voltage value can be adjusted to 50 V or 45 V. In particular, the threshold voltage value can be adjusted taking into account the currents occurring during operation in order to avoid excessive current values and thus excessive load on the rechargeable battery.

With the help of the appropriately designed converter, an increase in the rechargeable battery current when the rechargeable battery voltage (direct current voltage) falls can be prevented by reducing the total power taken from the rechargeable battery through a reduction of the frequency. Therein, it is, for example, possible to ensure that the rechargeable battery current drawn from the rechargeable battery is kept substantially constant or does not or increases only slightly.

The reduction in frequency, and thus in the motor frequency and the motor rotational speed, can also be perceived by the operator, e.g. acoustically. In this way, the operator receives the information that the rechargeable battery is running low and it may be advisable to replace or recharge the rechargeable battery.

Accordingly, the converting apparatus can be designed to reduce the frequency of the alternating current voltage according to a predetermined rule if the direct current voltage falls below the threshold voltage value. The rule can, for example, effect a linear reduction, a gradual reduction or a proportional reduction.

The converting apparatus can be designed to gradually reduce the frequency of the alternating current voltage when the direct current voltage falls below the threshold voltage value. If thus it is detected that the direct current voltage has fallen below the threshold voltage value, the frequency and thus also the motor rotational speed is gradually reduced. If the voltage falls below further values, the gradual reduction can be continued.

For example, the threshold voltage can be defined at a value of 45 Volts. If the voltage falls below the threshold voltage value, the frequency is gradually reduced, e.g. by 0.5 Hz for every 0.5 V (reduction in direct current voltage).

A voltage measuring device can be provided to measure the direct current voltage drawn from the energy storage. In addition, a power grid device can be provided to measure the current drawn from the energy storage.

The direct current voltage measured by the voltage measuring device can be used as a signal for adjusting the frequency through the converting apparatus.

The converting apparatus and the energy storage can be integrated into a single structural unit. This means that the energy storage and the converting apparatus can be replaced together as one unit. The converting apparatus can also be part of the battery control.

The converting apparatus can have a control apparatus that simultaneously also includes the battery control (rechargeable battery control) or the battery management system (BMS). Accordingly, the rechargeable battery control can control the converting apparatus in order to effect the intended reduction in frequency when the voltage falls below the threshold voltage value.

In a variant, the ground compaction device may be a tamper, wherein the working movement may then be a tamping movement, a tamping foot can be provided for compacting a ground, and wherein the working device can have a tamping device for generating the tamping movement of the tamping foot.

In another variant, the ground compaction device can be a vibrating plate, wherein the working movement can be a vibrating movement, a ground contact plate can be provided, the working device can have an unbalance exciter for generating the vibrating movement for producing the ground compaction, and wherein the vibrating movement can be transmitted to the ground contact plate.

The invention thus makes it possible to compensate for the increase in motor current when the voltage supplied by the rechargeable battery drops. Accordingly, the operating time of the rechargeable battery can be increased. The reduction in frequency alerts the operator to the fact that the charge level is low and that recharging may be advisable. The reduction in battery currents results in a lower cooling requirement. In addition, the service life of the rechargeable battery can also be extended.

### BRIEF DESCRIPTION OF THE DRAWINGS

These and further advantages and features are explained in more detail below using an example and with the help of the accompanying figures. In the figures:

FIG. 1 is a highly schematized illustration of the structure of a ground compaction device; and

FIG. 2 is the progression of a rechargeable battery voltage and a converter frequency over time.

### DETAILED DESCRIPTION

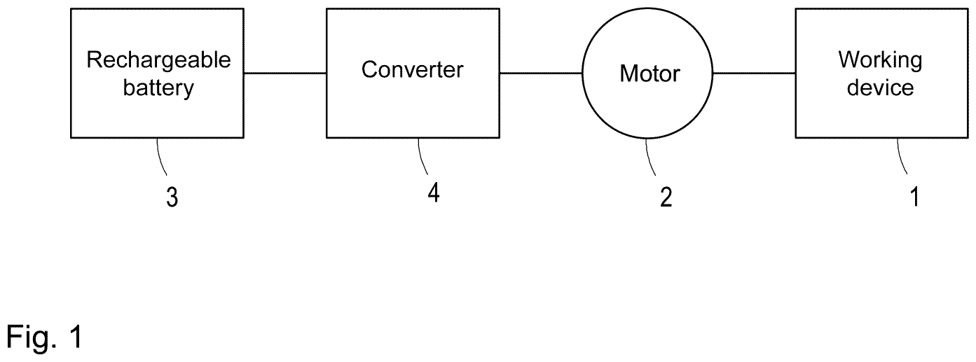

FIG. 1 shows the structure of a ground compaction device, e.g. a tamper or a vibrating plate, in a highly schematized manner.

The ground compaction device has a working device 1 with which the desired working movement for ground compaction can be caused. Accordingly, the working device 1 can be a tamping device (for a tamper) or an unbalance exciter (for a vibrating plate). The structure of a tamping device or an unbalance exciter is well known and therefore does not need to be explained in detail here.

The working device 1 is driven by an electric motor 2. The electric motor 2 can be spatially integrated into the working device 1. For example, the electric motor 2 can be part of the unbalance exciter serving as the working device 1. Alternatively, it is also possible to arrange the electric motor 2 spatially separated from the working device 1. In this case, appropriate transmission apparatuses, such as clutches, transmissions, belt drives, shaft drives, hydraulic drives, etc., must be provided in order to transmit the motor power of the electric motor 2 to the working device 1.

The electric motor 2 receives its electrical energy from a rechargeable battery 3 which serves as an electrical energy storage. The rechargeable battery 3 can be permanently integrated into the ground compaction device. Alternatively, it can be designed to be replaceable so that it can be quickly exchanged for a freshly charged replaceable battery 3 when empty.

The rechargeable battery 3 provides a direct current voltage. Since the electric motor 2 can be a synchronous machine, for example, it must be driven by an alternating current voltage. A converter 4 is provided to convert the direct current voltage of the rechargeable battery 3 into the appropriate alternating current voltage for the electric motor 2.

The converter 4 causes an alternating current voltage with a predetermined frequency. In the normal operating state, when the rechargeable battery 3 is sufficiently charged, the converter 4 provides the alternating current voltage with a predetermined control frequency, e.g. 150 Hz. Other frequency values can also be useful, depending on the design of the electric motor 2 and the desired use case.

As operation increases, the rechargeable battery 3 is discharged so that it can no longer provide the direct current voltage present in the fully charged state, e.g. 40-60 V. Rather, the voltage of the rechargeable battery 3 decreases with increasing operating duration. In order to still be able to provide the desired frequency (control frequency) for the electric motor 2, the electric motor requests a higher current from the rechargeable battery 3 via the converter 4. This leads to an increasing load and heating of the rechargeable battery 3. The service life of the rechargeable battery 3 can also be affected over time.

In order to prevent the undesired increase in the rechargeable battery current, the converter 4 or a control apparatus of the rechargeable battery 3 (battery control) connected to the converter is designed according to the invention to reduce the frequency of the alternating current voltage and thus the motor frequency of the electric motor 2 when the direct current voltage of the rechargeable battery 3 falls below a certain threshold voltage value.

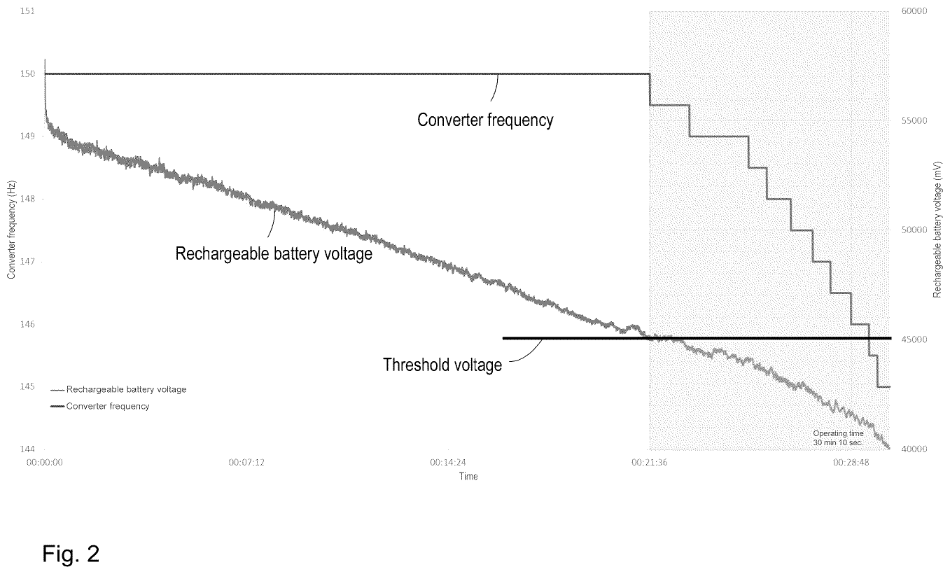

FIG. 2 explains this connection in more detail. There, the progression of the rechargeable battery voltage and the converter frequency or motor frequency over time (operating time) is plotted. In the example shown, an operating time of approx. 30 min is considered.

As soon as the electric motor 2, and thus the ground compaction device, is started, the voltage present in the idle state (approx. 57 V or 57,000 mV) falls to a value below 55 V. The motor frequency (and thus the alternating current voltage frequency) is adjusted to a value of 150 Hz by the converter 4 (control frequency).

During operation, the voltage decreases further, as can be seen from the drop in the “rechargeable battery voltage” curve in FIG. 2.

In the example shown, the direct current voltage of the rechargeable battery 3 drops below a value of 45 V after 21 minutes and 36 seconds (00:21:36″). This value is defined as the threshold voltage.

The converter 4 interprets the drop in voltage to mean that the rechargeable battery 3 has already been discharged in a significant part. In return, the currents requested by the rechargeable battery 3 through the electric motor 2 and the converter 4 are progressively increased so that the electric motor 2 can constantly deliver the required power to drive the working device 1.

However, when the rechargeable battery voltage falls below the threshold voltage (45 V), converter 4 changes the frequency. In the present example, the frequency of 150 Hz is reduced stepwise by 0.5 Hz for every 0.5 V fall in voltage. Accordingly, if the rechargeable battery voltage falls by 0.5 V, the motor frequency is reduced by 0.5 Hz, as shown in FIG. 2 by the gradual decrease in frequency. This means that when the battery voltage falls from 45 to 40 V, the converter frequency is reduced from 150 Hz to 145 Hz.

In turn, this can prevent or at least reduce a further increase in the motor currents and thus the currents drawn from the rechargeable battery 3. This results in the rechargeable battery being conserved accordingly. In addition, less cooling is required for the rechargeable battery 3.

1. A ground compaction device, comprising:
a working device for generating a working movement for ground compaction;
an electric drive for driving the working device;
an electrical energy storage for providing electrical energy for the electric drive; and
a converting apparatus for converting a direct current voltage that can be drawn from the energy storage into an alternating current voltage for the electric drive; wherein
the converting apparatus is designed to
provide the alternating current voltage at a predetermined control frequency when the direct current voltage drawn from the energy storage is at a direct current voltage value above a predetermined threshold voltage value; and to
provide the alternating current voltage at a reduced frequency that is lower than the control frequency when the direct current voltage drawn from the energy storage has a direct current voltage value equal to or below the threshold voltage value.

2. The ground compaction device according to claim 1, wherein the converting apparatus is designed to reduce the frequency of the alternating current voltage in accordance with a predetermined rule when the direct current voltage falls below the threshold voltage value.

3. The ground compaction device according to claim 1, wherein the converting apparatus is designed to gradually reduce the frequency of the alternating current voltage when the direct current voltage falls below the threshold voltage value.

4. The ground compaction device according to claim 1, wherein a voltage measuring device is provided for measuring the direct current voltage drawn from the energy storage.

5. The ground compaction device according to claim 1, wherein the direct current voltage measured by the voltage measuring device can be used as a signal for adjusting the frequency through the converting apparatus.

6. The ground compaction device according to claim 1, wherein the converting apparatus and the energy storage are integrated in one structural unit.

7. The ground compaction device according to claim 1, wherein
the ground compaction device is a tamper;
the working movement is a tamping movement;
a tamping foot is provided for compacting a ground; and
the working device has a tamping device for generating the tamping movement of the tamping foot.

8. The ground compaction device according to claim 1, wherein
the ground compaction device is a vibrating plate;
the working movement is a vibrating movement;
a ground contact plate is provided;
the working device has an unbalance exciter for generating the vibrating movement for ground compaction; and
the vibrating movement is transmitted to the ground contact plate.
